(19) United States
(12) Patent Application Publication
(10) Pub. No.: US 2008/0127809 A1
(43) Pub. Date: Jun. 5, 2008

(54) Electronic display stand

(76) Inventor: Chia-Cheng Fu, Taipei City (TW)

Correspondence Address: BIRCH STEWART KOLASCH & BIRCH, PO BOX 747, FALLS CHURCH, VA, 22040-0747, US

(21) Appl. No.: 11/606,349

(22) Filed: Nov. 30, 2006

(51) Int. Cl. G09B 15/02

(52) U.S. Cl. 84/477 R

(57) ABSTRACT

An electronic display stand includes a face panel and a single foot stand located on the bottom of the face panel. The face panel has a display screen located on the top surface and electronic control elements located inside that are electrically connected to the display screen. The face panel further has a switch, a pushbutton and an insertion port located thereon that are electrically connected to the electronic control elements. The insertion port can be coupled with an external data entry device (such as a card reader, various external storage devices and the like). Thereby data on the data entry device can be displayed on the electronic display stand such as musical scores, teaching materials, guiding materials and the like to facilitate data entry and fast and convenient reading.

### FIELD OF THE INVENTION

The present invention relates to an electronic display stand and particularly to an electronic display stand for displaying data such as musical scores, teaching materials, guiding materials and the like to enable users to do other activities while reading the data.

### BACKGROUND OF THE INVENTION

A holding stand is commonly used for holding document data such as musical scores during concerts or teaching materials while teachers do lecturing in classrooms so that people can do other activities easier with two hands such as musicians can play the musical instruments and the teachers can write and do lecturing smoother. In some other occasions such as at the doors of restaurants, museums and the like, a holding stand is set to hold guiding materials such as menu, product information and the like to enable customers to understand the products and services in advance.

However there are problems when the conventional holding stand is in use. For instance to hold the musical scores during a concert, such as playing a violin, the performer has to flip the musical scores on the holding stand by hand periodically. In the event that a correct page of the musical scores is not being flipped properly, the performer often has to do it again in a flustered manner, and performance quality is affected. In another instance, for holding teaching materials during lecturing or guiding materials, the teaching or guiding materials could be scattered untidily due to blowing of wind or other external factors. The teacher has to flip the book manually to the correct page, this causes distraction, or product information is not clearly presented. The result of lecturing or product presentation suffers. Hence there is still room for improvement on the conventional holding stand.

### SUMMARY OF THE INVENTION

Therefore the primary object of the present invention is to solve the aforesaid problems occurred to the conventional holding stand.

To achieve the foregoing object the invention provides an electronic display stand that mainly includes a face panel, a foot stand located on the bottom of the face panel and a display screen on the top surface of the face panel that has electronic control elements located inside connecting electrically to the display screen. The face panel has a switch, a pushbutton and an insertion port that are electrically connected to the electronic control elements. The insertion port can be coupled with an external card reader. The electronic control elements can process data of memory cards inserting into the card reader and transmit the data on the display screen that are controlled by the pushbutton.

By means of the construction set forth above, the insertion port can be coupled with a data entry device to receive memory cards that store data such as musical scores, teaching materials, guiding materials and the like and load the data, and display the data on the display screen to be used on musical performances, lecturing, products and services presentations and the like. Such a design does not require complicated operations occurred to the general computers. It can be operated easily and quickly to facilitate presentation.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the electronic display stand of the invention.

### DETAILED DESCRIPTION OF THE PREFERRED EMBODIMENT

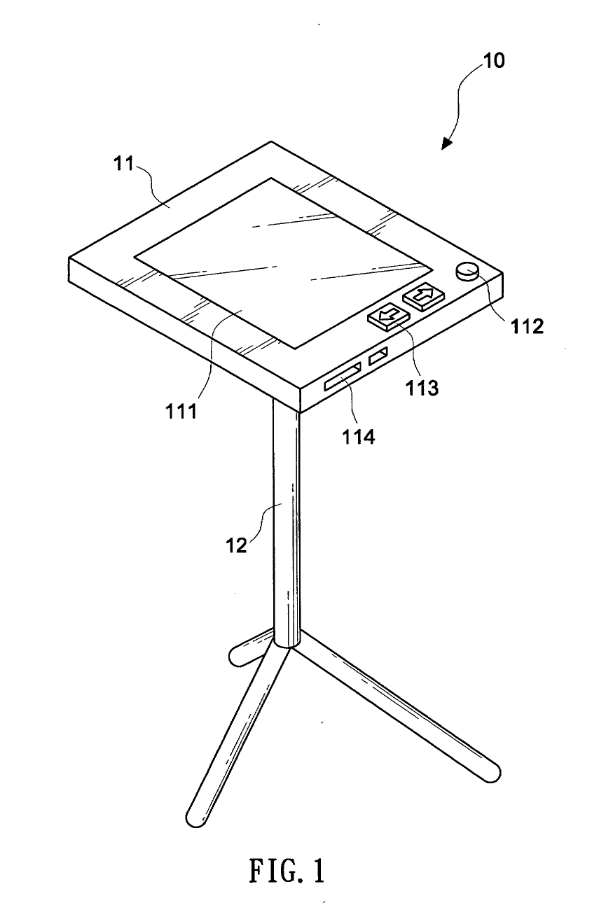

Please refer to FIG. 1, the electronic display stand 10 according to the invention mainly includes a face panel 11 which is supported by a foot stand 12 on the bottom. The face panel 11 has a display screen 111 on the top surface that contains electronic control elements (not shown in the drawing) electrically connecting to the display screen 111. The face panel 11 has a switch 112, a pushbutton 113 and an insertion port 114 located thereon that are electrically connected to the electronic control elements. The insertion port 114 can be coupled with an external data entry device (such as card reader, external storage device and the like). For instance, if the data entry device is a card reader, a memory card can be inserted to allow the electronic control elements to process data in the memory card and display the data on the display screen 111. Thereby users can read and scroll the contents through the pushbutton 113.

The insertion port 114 may also be a commonly used USB port to be coupled with a data entry device equipped with a USB cable now available on the market.

When in use, with a card reader serving as a data entry device as an example in the following discussion, the display screen 111 is activated by the electronic control elements through the switch 112. The insertion port 114 is coupled with the card reader to receive a memory card which stores musical scores. The electronic control elements perform data processing and display data on the display screen 111. Users can perform by looking at the musical scores displayed on the display screen 111. After a selected interval the musical scores displayed on the display screen 111 can be turned to another page through the pushbutton 113. Therefore music performance is much more convenient.

The insertion port 114 that is connected to the card reader can also receive another memory card containing teaching materials. During lecturing a teacher can display the teaching materials displayed on the display screen 111 through the pushbutton 113 and turn pages as desired to make lecturing smoother. The card reader can also receive other memory cards that store various types of guiding materials to provide product and service presentation at the doors of restaurants, museums and the like. Page scrolling or turning also can be accomplished rapidly.

In short, the electronic display stand 10 of the invention provides the following main features:

1. When the electronic display stand 10 is used in concerts, a performer can rapidly scroll the musical scores displaying on the display screen 111 through a simple push action. Thus the performer can focus more attention on playing of the musical instrument to improve performance quality.

2. When the electronic display stand 10 is used for lecturing or guiding purpose, users can smoothly scroll data contents displaying on the display screen 111 through a simple push action. Hence the users can focus on lecturing and reading of product descriptions without concerning scattering of the teaching materials caused by blowing winds that might otherwise occur to the conventional holding stand.

As previously discussed, the electronic display stand 10 of the invention can display data such as musical scores, teaching materials, guiding materials and the like in concerts, lecturing, product and service presentation and the like. It does not need the complicated operations occurred to the general computer, and can be operated easily and quickly to make handy presentation. It is more convenient to use.

What is claimed is:

1. An electronic display stand comprising a face panel, a single foot stand located on the bottom of the face panel and a display screen on a top surface of the face panel, the face panel housing electronic control elements that are electronically connected to the display screen and having a switch, a pushbutton and an insertion port located thereon that are electrically connected to the electronic control elements, the insertion port being connectable to an external data entry device, the electronic control elements processing data located in the data entry device and transmitting the data to the display screen for displaying that are controlled through the pushbutton.

2. The electronic display stand of claim 1, wherein the insertion port is a USB port.
